(19) United States
(12) Patent Application Publication
(10) Pub. No.: US 2002/0031103 A1
(43) Pub. Date: Mar. 14, 2002

(54) User terminal employing quality of service path determination and bandwidth saving mode for a satellite ISP system using non-geosynchronous orbit satellites

(75) Inventors: Robert A. Wiedeman, Sedalia, CO (US); Prashant V. Waknis, Mountain View, CA (US)

Correspondence Address: Harry F. Smith, Esq., Ohlandt, Greeley, Ruggiero & Perle, L.L.P., One Landmark Square, 10th Floor, Stamford, CT, 06901-2682, US

(73) Assignee: GLOBALSTAR L.P., SAN JOSE, CA (US)

(21) Appl. No.: 09/841,862

(22) Filed: Apr. 25, 2001

Related U.S. Application Data
(60) Provisional application No. 60/201,111, filed on May 2, 2000.

(51) Int. Cl. H04B 7/185

(52) U.S. Cl. 370/316; 370/389

(57) ABSTRACT

Methods are provided for operating a mobile satellite telecommunications system, as is a system that operates in accordance with the methods. A first method has steps of providing at least one user terminal, at least one satellite in earth orbit and at least one gateway bidirectionally coupled to a data communications network and, responsive to applications, selecting with the user terminal individual ones of a plurality of Quality of Service (QoS) modes for servicing different application requirements. The method further includes communicating a request for a selected one of the QoS modes at least to the gateway. Another method operates in response to stored satellite ephemeris information for selecting a path through the satellite constellation to a destination gateway for routing a communication to or from the data communication network and the user terminal, and for transmitting a description of the selected path from the user terminal to at least one of the constellation of satellites. Another method operates so as to reduce an amount of information contained within a packet header after transmitting a first packet to at least one satellite of the constellation of satellites. Preferably the packet header of the first packet contains information that is descriptive of at least an identification of a source address and a destination address of the packet, and a connection identifier identifying a communication connection to which the packet belongs, whereas headers of subsequent packets of the communication connection contain only the connection identifier. The method further extracts and stores the information from the header of the first packet in the satellites, and routes subsequent packets based on the stored information and on the connection identifier. The method further expands the subsequently transmitted packet headers to contain the stored information prior to being transmitted to the data communication network.

### CLAIM OF PRIORITY FROM COPENDING PROVISIONAL PATENT APPLICATION

This application claims priority under 35 U.S.C. 119(e) and 120 from provisional patent application No. 60/201,111, filed on May 2, 2000, the disclosure of which is incorporated by reference herein in its entirety.

### FIELD OF THE INVENTION

These teachings relate generally to satellite-based communication systems and, more particularly, relate to non-geosynchronous orbit satellite communication systems, such as Low Earth Orbit (LEO) and Medium Earth Orbit (MEO) satellite communication systems.

### BACKGROUND OF THE INVENTION

In U.S. patent application Ser. No. 09/334,386, filed Jun. 16, 1999, entitled “ISP System Using Non-Geosynchronous Orbiting Satellites,” by Robert A. Wiedeman, there are disclosed embodiments of satellite-based communication systems that extend the Internet using non-geosynchronous orbit satellites. A user in a remote location can use the LEO constellation to access the Internet. The satellites in this system become part of the Internet and act as access points for User Terminals (UTs) in remote areas. This U.S. patent application is incorporated by reference in its entirety, insofar as it does not conflict with these teachings.

In general, a UT may have the capability to use a circuit-switched or a packet-switched mode to connect to a device at the other end, either on the Public Switched Telephone Network (PSTN) or on the Public Data Network (PDN). However, due to various Quality of Service (QoS) requirements and constraints, one particular mode of operation may be better than another at a particular time. Other considerations also exist, such as a best path for routing a communication, and the conservation of system bandwidth to maximize system capacity and reduce cost.

As such, a need exists to enable some type of UT selectivity, control and autonomy over the operational modes and other aspects of the communications of the UT during data transfer and other types of communication operations.

### SUMMARY OF THE INVENTION

The foregoing and other problems are overcome by methods and apparatus in accordance with embodiments of these teachings.

In a first aspect of these teachings a method is provided for operating a mobile satellite telecommunications system, as is a system that operates in accordance with the method. The method has steps of providing at least one user terminal, at least one satellite in earth orbit and at least one gateway bidirectionally coupled to a data communications network and, responsive to applications, selecting with the user terminal individual ones of a plurality of Quality of Service (QoS) modes for servicing different application requirements. The method further includes communicating a request for a selected one of the QoS modes at least to the gateway, and in response allocating resources to accommodate the requested QoS mode. The method may select one of a circuit switched or a packet switched mode of operation with the user terminal. Preferably the user is billed a greater amount for use of a QoS of higher quality.

The QoS modes include a Highest Quality of Service mode, a Medium Quality of Service mode, a Best Available Quality of Service mode, and a Guaranteed Data Rate Packet Data Service mode.

In a further aspect of these teachings a method provides at least one user terminal, a constellation of satellites in earth orbit and at least one gateway bidirectionally coupled to a data communications network and, in response to at least stored satellite ephemeris information, selects a path through the satellite constellation to a destination gateway for routing a communication to or from the data communication network and the user terminal, and transmits a description of the selected path from the user terminal to at least one of the constellation of satellites. The selection of the path is further responsive to stored gateway location information for selecting the path through the satellite constellation to the destination gateway.

In a further aspect of these teachings a method provides at least one user terminal, a constellation of satellites in earth orbit and at least one gateway bidirectionally coupled to a data communications network, and operates so as to reduce an amount of information contained within a packet header after transmitting a first packet to at least one satellite of the constellation of satellites. Preferably the packet header of the first packet contains information that is descriptive of at least an identification of a source address and a destination address of the packet, and a connection identifier identifying a communication connection to which the packet belongs. Headers of subsequent packets of the communication connection may contain only the connection identifier. The method further extracts and stores the information from the header of the first packet in the satellites, and routes subsequent packets based on the stored information and on the connection identifier. The method further expands the subsequently transmitted packet headers to contain the stored information prior to being transmitted to the data communication network.

### BRIEF DESCRIPTION OF THE DRAWINGS

The above set forth and other features of these teachings are made more apparent in the ensuing Detailed Description of the Preferred Embodiments when read in conjunction with the attached Drawings, wherein:

FIG. 1 is a simplified block diagram of a mobile satellite telecommunications system (MSTS) that is suitable for practicing these teachings;

FIG. 2 is a logical diagram of the UT of FIG. 1, showing the relationship between UT applications, an applications interface and an air interface; and

FIG. 3 shows a first type of packet and a second type of packet, having a reduced header size, in accordance with an aspect of these teachings.

### DETAILED DESCRIPTION OF THE PREFERRED EMBODIMENTS

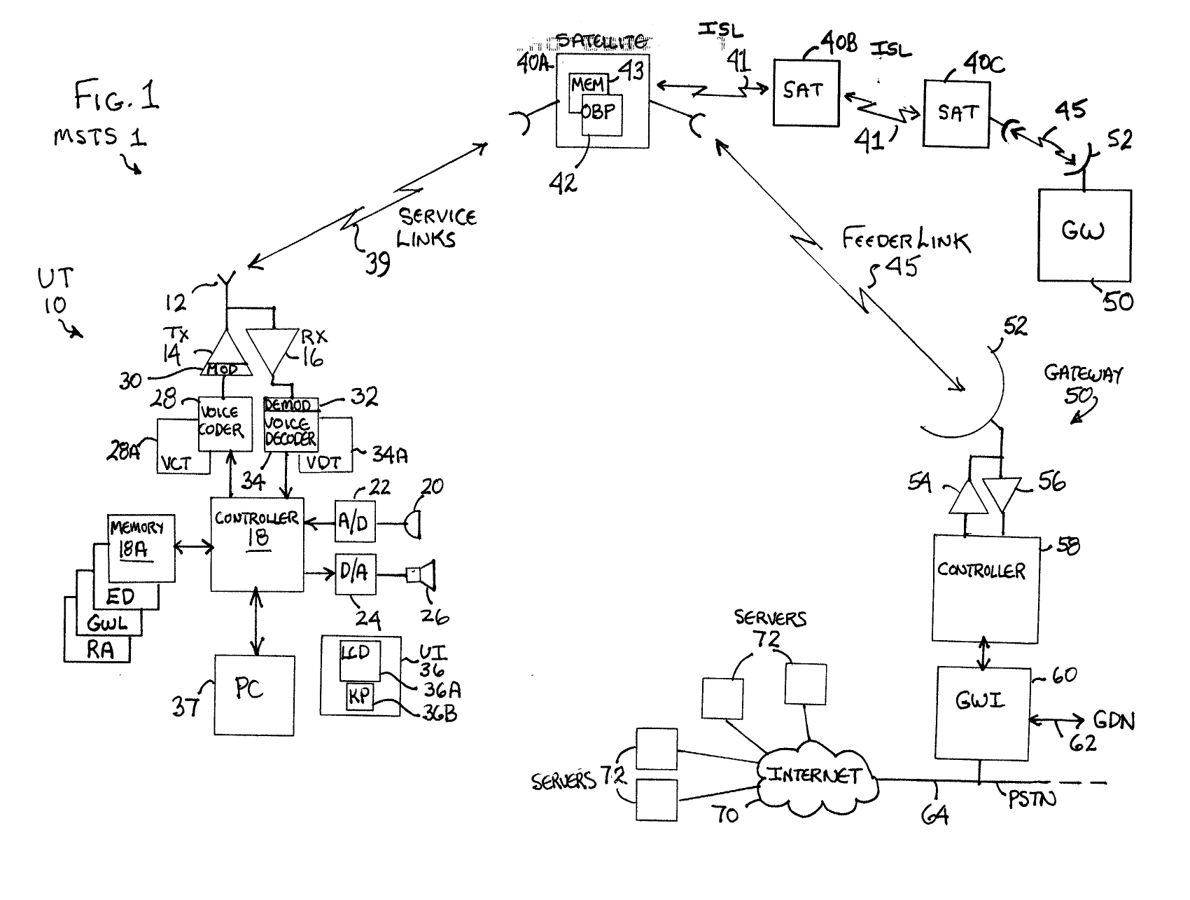

Reference is made to FIG. 1 for illustrating a simplified block diagram of a digital wireless telecommunications system, embodied herein as a mobile satellite telecommunications system (MSTS) 1, that is suitable for practicing these teachings. While described in the context of the MSTS 1, those skilled in the art should appreciate that certain of these teachings may have application to terrestrial telecommunications systems as well.

The MSTS 1 includes at least one, but typically many, wireless user terminals (UTs) 10, at least one, but typically several, communications satellite 40, and at least one, but typically several, communications ground stations or gateways 50. In FIG. 1 three satellites are shown for convenience, with one being designated satellite 40A, one satellite 40B and one satellite 40C, hereafter collectively referred to as satellite or satellites 40. The satellites 40 preferably contain an on-board processor (OBP) 42 and an on-board memory (MEM) 43. An Inter-Satellite Link (ISL) 44 is shown between satellites 40A, 40B and 40C. The ISL 41 could be implemented using an RF link or an optical link, and is modulated with information that is transferred between the satellites 40, as described in further detail below. More than three satellites 40 can be coupled together using ISLs 41.

Reference with regard to satellite-based communications systems can be had, by example, to U.S. Pat. No. 5,526,404, “Worldwide Satellite Telephone System and a Network Coordinating Gateway for Allocating Satellite and Terrestrial Resources”, by Robert A. Wiedeman and Paul A. Monte; to U.S. Pat. No. 5,303,286, “Wireless Telephone/ Satellite Roaming System”, by Robert A. Wiedeman; to U.S. Pat. No. 5,619,525, “Closed Loop Power Control for Low Earth Orbit Satellite Communications System, by Robert A. Wiedeman and Michael J. Sites; and to U.S. Pat. No. 5,896,558 “Interactive Fixed and Mobile Satellite Network”, by Robert A. Wiedeman, for teaching various embodiments of satellite communications systems, such as low earth orbit (LEO) satellite systems, that can benefit from these teachings. The disclosures of these various U.S. patents are incorporated by reference herein in their entireties, in so far as they do not conflict with the teachings of this invention.

The exemplary UT 10 includes at least one antenna 12, such as an omni-directional antenna or a directional antenna, for transmitting and receiving RF signals over service links 39, and further includes an RF transmitter (TX) 14 and an RF receiver (RX) 16 having an output and an input, respectively, coupled to the antenna 12. A controller 18, which may include one or more microprocessors and associated memories 18a and support circuits, functions to control the overall operation of the UT 10. An input speech transducer, typically a microphone 20, may be provided to input a user's speech signals to the controller 18 through a suitable analog to digital (A/D) converter 22. An output speech transducer, typically including a loudspeaker 26, may be provided to output received speech signals from the controller 18, via a suitable digital to analog (D/A) converter 24. The UT 10 may also include some type of user interface (UI) 36 that is coupled to the controller 18. The UI 36 can include a display 36A and a keypad 36B. The UT 10 may also be coupled with a computing device, such as a laptop computer or a PC 37, and may thus function as a wireless modem for the PC 37.

A transmit path may include a desired type of voice coder (vocoder) 28 that receives a digital representation of the input speech signals from the controller 18, and includes voice coder tables (VCT) 28a and other required support circuitry, as is well known in the art. The output of the vocoder 28, which is a lower bit rate representation of the input digital speech signals or samples, is provided to a RF modulator (MOD) 30 for modulating a RF carrier, and the modulated RF carrier is upconverted to the transmission frequency and applied to the input to the RF transmitter amplifier 14. Signaling information to be transmitted from the UT 10 is output from the controller 18 to a signaling path that bypasses the vocoder 28 for application directly to the modulator 30. Not shown or further discussed is the framing of the transmitted signal for a TDMA type system, or the spreading of the transmitted signal for a CDMA type system, since these operations are not germane to an understanding of this invention. Other operations can also be performed on the transmitted signal, such as Doppler precorrection, interleaving and other well known operations.

A receive path may include the corresponding type of voice decoder 34 that receives a digital representation of a received speech signal from a corresponding type of demodulator (DEMOD) 32. The voice decoder 34 includes voice decoder tables (VDT) 34a and other required support circuitry, also as is well known in the art. The output of the voice decoder 34 is provided to the controller 18 for audio processing, and is thence sent to the D/A converter 24 and the loudspeaker 26 for producing an audible voice signal for the user. As with the transmitter path, other operations can be performed on the received signal, such as Doppler correction, de-interleaving, and other well known operations. In a manner analogous to the transmit path, received signaling information is input to the controller 18 from a signaling path that bypasses the voice decoder 34 from the demodulator 32.

It is pointed out that the above-mentioned voice and audio capability is not required to practice these teachings, as the UT 10 may operate solely as a data communications device. In this mode of operation the vocoder(s) may simply be bypassed, and the data signals modulated/demodulated, interleaved/deinterleaved, etc. In a data-only application the UT 10 may be constructed so as not to include any analog voice capability at all. Furthermore, in a data-only application the user interface 36 may not be required, particularly if the UT 10 is wholly or partially embedded within another device, such as the PC 37.

The RF signals transmitted from the UT 10 and those received by the UT 10 over the service links 39 pass through at least one satellite 40, which may be in any suitable altitude and orbital configuration (e.g., circular, elliptical, equatorial, polar, etc.) In the preferred embodiment the satellite 40 is one of a constellation of non-geosynchronous orbit (non-GEO) satellites, preferably Low Earth Orbit (LEO) satellites, although one or more Medium Earth Orbit (MEO) satellites could be used as well, as could one or more geosynchronous orbit satellites in conjunction with LEO or MEO satellites. In the preferred embodiment the satellite 40 has the on-board processor (OBP) 42, wherein a received transmission is at least partially demodulated to baseband, processed on the satellite 40, re-modulated and then transmitted. As will be discussed below, in accordance with an aspect of these teachings the on-board processing conducted by the satellite 40 includes routing a received packet based on stored route information selected by the UT 10.

The satellite 40 serves to bidirectionally couple the UT 10 to the gateway 50. The gateway 50 includes a suitable RF antenna 52, such as steerable parabolic antenna, for transmitting and receiving a feederlink 45 with the satellite 40. The feederlink 45 will typically include communication signals for a number of UTs 10. The gateway 50 further includes a transceiver, comprised of transmitters 54 and receivers 56, and a gateway controller 58 that is bidirectionally coupled to a gateway interface (GWI) 60. The GWI 60 provides connections to a Ground Data Network (GDN) 62 through which the gateway 50 communicates with a ground operations control center (not shown) and possibly other gateways. The GWI 60 also provides connections to one or more terrestrial telephone and data communications networks 64, such as the PSTN. PLMN, and/or PDN, whereby the UT 10 can be connected to any wired or wireless telephone, or to another UT, through the terrestrial telecommunications network. In accordance with an aspect of these teachings the gateway 50 provides an ability to reach the Internet 70, which provides access to various servers 72. The gateway 50 also includes banks of modulators, demodulators, voice coders and decoders, as well as other well known types of equipment, which are not shown to simplify the drawing.

Having thus described one suitable but not limiting embodiment of a mobile satellite telecommunications system that can be used to practice these teachings, a description of the preferred embodiments of these teachings will now be a provided.

These teachings add the following capabilities to the UT 10:

1. a capability to define the QoS required based on the application;

2. a capability to request a QoS from the air-interface;

3. a capability to define a path (within the satellite system) to the destination; and

4. a capability to minimize overhead by reducing header lengths of packets once the connection is established.

There are potentially at least two types of communication possible.

Circuit Switched Communication:

In this type of communication, the UT 10 typically requests a circuit. The circuit may be established between two UT's or between a UT 10 and some device on a terrestrial voice network (such as the PSTN or the Public Land Mobile Network (PLMN) or on a terrestrial data network (such as the Internet). When the UT 10 makes a request for the circuit, the UT 10 typically also requests some parameters associated with the circuit. Bandwidth of the transfer is one such parameter. When a circuit is granted to the UT 10, typically a physical channel or path for the transfer is also defined for a period of time.

Packet Switched Connection:

The other type of communication is achieved by packet-switching, in which no physical channel is assigned to the UT 10. Instead, the UT 10 transmits a packet with a destination address for the packet. A satellite 40 receives the packet and decides the next hop based on the destination address, thereby routing the packet. No path is set-up for this type of communication, as the actual path from the UT 10 to the destination can change packet by packet.

A first aspect of these teachings relates to a UT 10 having a capability to define the QoS.

In the MSTS 1, as discussed above, there are the UTs 10, satellites 40, gateways 50, and public/private voice and/or data networks. In a UT 10 originated call, the UT 10 is the entity has knowledge of the application and the application's requirements. The satellites 40, the gateway 50 and other nodes in the PSTN 64 or PLMN provide bandwidth and other resources to facilitate this communication. Since the UT 10 knows the application's requirements, these teachings enable the UT 10 to make the QOS decision.

The are a variety of QoS modes, examples of which are as follows.

Highest Quality of Service:

For voice or data calls, the highest quality may mean that the UT 10 requires a certain data-rate from the circuit established between the UT 10 and the destination. The UT 10 is enabled to define the minimum data-rate that is acceptable to service the application. The amount charged for this type of service will typically be greater than for other services. An example application for this type of service is the real-time transfer of multi-media contents between the UT 10 and the other party to the communication.

Medium Quality of Service:

The applications served by this QoS may still use the circuit switched mechanism in the UT 10. However, the UT 10 may not have the ability to specify the bandwidth requirement. The UT 10 in this case determines the bandwidth based on the current system state. An example of this application is be a typical voice communication application.

Best Available Quality of Service:

This service may not establish a circuit at all, and communication is preferably achieved in the packet switched mode. The UT 10 and the satellites 40, with on-board processing capability, make all routing decisions based on the destination address in each individual packet.

Guaranteed Data Rate Packet Data Service:

In this service, although packet switching is used for the communication between the UT 10 and the destination, the path may be defined for packet streams for a period of time, and bandwidth reserved by the satellite 40 on-board processors 42 for the packet streams.

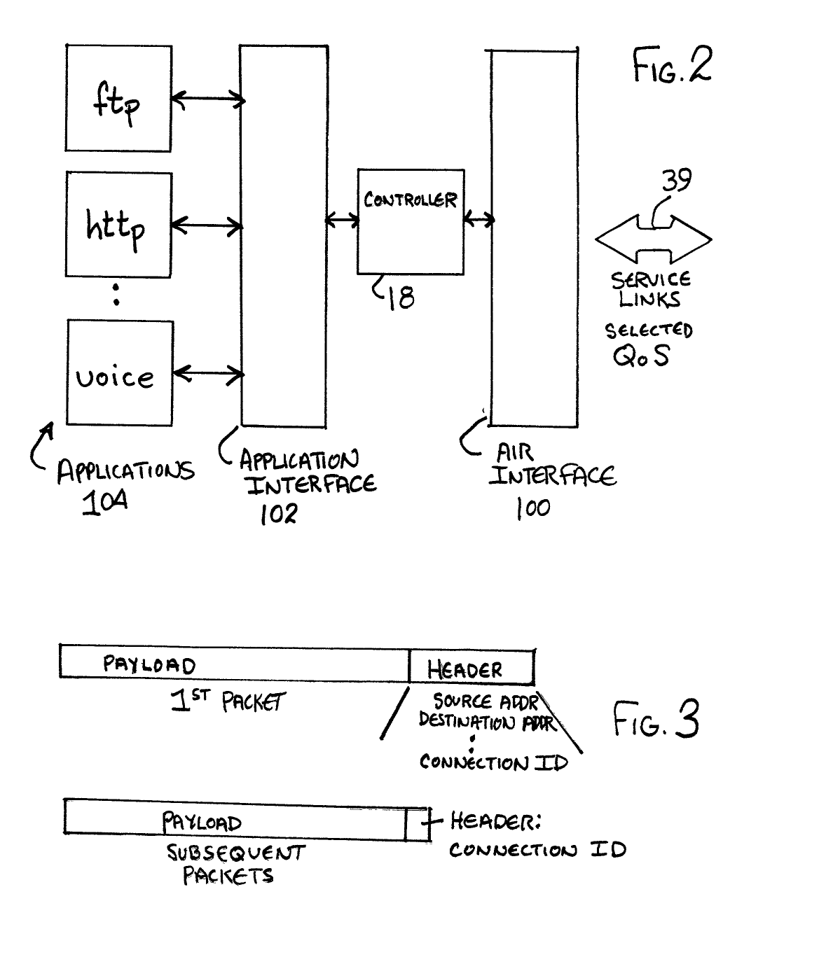

Referring to FIG. 2, the UT 10 includes an air interface 100 through which data is sent back and forth to the gateway 40 over the service links 39. The UT 10 also has an application interface 102 through which data is sent back and forth to applications 104. Examples of typical applications 104 are ftp, http, voice, etc. The UT 10 also has the capability to determine which application 104 is being used. The UT 10 may achieve this by examining the packets that are received by the application interface 102, and an algorithm in UT 10 uses this information to determine what quality of service (QoS) should be provided to serve the application 104. Once the UT 10 decides the QoS that the application 104 should receive, the UT 10 negotiates with the gateway 50 for the QoS during the call establishment procedure, using predefined signaling messages and protocols sent over the service links 39.

The QoS algorithm run by the UT 10 may be as simple or as complex as desired. For example, the QoS algorithm may maintain a look-up table (LUT) that associates each application 104 with a predetermined QoS. Through the UI 36 the user may request a particular QoS, thereby overriding the UT 10 determined QoS. The QoS may also be a function of the amount of data to be transferred, or of a file extension appended to the data file to be transferred, or may be based on the destination address, where certain destination addresses (e.g., certain servers 72) are predetermined to use a certain QoS, while other destination addresses use a different QoS, etc.

A second aspect of these teachings relates to a UT 10 having a capability to request a QoS from the air-interface 100.

The components involved in the operation of the air interface include the UT 10, the gateway 50, as well as the number of satellites 40 between the UT 10 and the gateway 50. When a UT 10 requests a resource, such as bandwidth, a resource allocation protocol (such as RSVP, being developed by IETF, described in IETF RFP 2205) may be used to guarantee the availability of that resource on all the components in the air interface.

For example, assume that the UT 10 requests a bandwidth of X bits/second between its antenna 12 and the PSTN 64 for a particular period of time. The satellite 40 on-board processor 42 and the gateway controller 58 may in this case communicate over a signaling channel so as to reserve sufficient satellite and gateway resources and capacity between themselves to guarantee that the UT 10 bandwidth request will be met.

A third aspect of these teachings relates to a UT 10 having a capability to define a path (within the MSTS 1) to the destination.

In this regard it can be appreciated that the gateway 50, the moving non-GEO satellites 40, and all of the active UTs 10 essentially form a routing network. All of the nodes in the network require a capability to communicate with other nodes. In satellite systems with on-board routing capability, the satellites employ a routing algorithm and ephemeris data of the moving satellite constellation to route the packets and close the circuits. In this case the satellites may have the inter-satellite links (ISLs) 41 for providing communication RF or IR paths between satellites in space, thereby enabling a packet to be routed from one satellite to another until the packet is finally downlinked to either the UT 10 or to the gateway 50.

However, having the satellites execute the routing algorithm and route the packets can be expensive. The routing algorithm on the satellites may also demand a large amount of memory 43 usage by the satellite on-board processor 42.

To avoid these problems, and referring again to FIG. 1, the UT 10 has the capability to set up connections and route the packets. In this aspect of these teachings the memory 18A, or an external memory that is accessible to the UT 10, stores the ephemeris data (ED) of the moving satellite constellation. The memory 18A also stores information that specifies the locations of the gateways 50 (GWL), including the location of the gateway that the UT 10 is attempting to reach. With this information, and using a routing algorithm (RA) also stored in the memory 18A, the controller 18 of the UT 10 is enabled to define a path through one or more satellites 40 to the gateway 50 that the UT 10 desires to access. Once a UT 10 has determined the path as defined by the nodes in the path (e.g, satellite 40A to satellite 40B to satellite 40C to gateway X, it establishes a circuit to the desired gateway by transmitting pathing or routing-related information to the satellites 40, defining which satellite(s) 40 are to participate in the path between the UT 10 and the desired gateway. In this manner the UT 10 essentially establishes a circuit in space between itself and a desired terrestrial termination point for the communication.

Note that it is within the scope of these teachings to store the ephemeris data, gateway location data and the routing algorithm in the attached PC 37, to execute the routing algorithm in the PC 37, and to transmit the selected route to the satellite or satellites 40 using the UT 10 service links 39.

Note should also be made that due to movement of the satellites 40 during the communication, it may be necessary to re-specify the participant satellites of the path, either initially or during the communication.

A fourth aspect of these teachings relates to a UT 10 having a capability to minimize communication overhead by reducing header lengths of the packets once a connection is established.

Whenever a UT 10 has a well-defined path to the destination, whether the path is determined by the UT 10 or by another router or routers, the UT 10 has the ability to establish the path for the duration of the connection. The satellites 40 in the path recognize the path as belonging to this particular UT 10 connection. The packet headers may then have a “connection identifier” field to identify this connection. This connection identifier field, after the first packet is sent, may then be used to also define the source address, the destination address, the type of connection, the service type, etc. Referring also to FIG. 3, after the UT 10 sends the first packet to the destination successfully (as verified by an acknowledgment, or less preferably by a lack of a non-acknowledgment) for a particular connection, the UT 10 is enabled to reduce the header information substantially by eliminating certain information. The UT 10 may eliminate all of the header information from subsequent packets except for the connection identifier (ID) field, which is used by all the satellites 40 along the defined path to identify the connection and to forward the packets (with reduced headers) appropriately. In this case the packet payload portion may remain the same length or, if desired, the payload portion may be increased by an amount that corresponds to the reduction in the size of the packet header.

The operation of the MSTS 1 with the connection identifier packet header field can be described as follows. When the UT 10 sends the first packet for the connection to the destination, it includes the connection identifier in the packet. The satellites 40 along the path note and store the header information, along with the connection identifier. In particular, the satellite on-board processors form tables that define the destination points for the connection identifiers. When the UT 10 (or a sender) receives an acknowledgment from the destination, the UT 10 knows that all of the satellites 40 have their tables formed correctly. At this time the UT 10 may eliminate certain fields from the packet header (e.g., one or more, or all, of the source address, the destination address, the type of connection, the service type fields, etc.), with the exception of the connection identifier field. A flag may also be set in the header to identify it to the satellites 40 as being a reduced or minimized packet header. The satellites 40 then use the connection identifier information to route each of the packets to appropriate ports for ISL 41 transmissions, if required, and to eventually downlink the packets to the desired gateway 50.

Note that the desired gateway 50 also received the original packet header, and preferably stored the information such as the source address, destination address, etc. As such, upon the receipt of the subsequent packets with minimized headers, the gateway 50 is enabled to add back into the packet header that information that was removed by the UT 10 before forwarding the packets on to the terrestrial communication system, such as the Internet. In this manner the packets with minimized headers are made fully compliant with the terrestrial packet transfer protocol in use, such as TCP/IP. Note that this function could as well be performed by one of the satellites 40, preferably the last satellite in the path before the packets are downlinked to the gateway 50.

The reduction in header size has at least two benefits. First, because the satellites 40 are not required to read all of the header information, the processing time at each satellite 40 is reduced, as the satellites 40 can determine the destination based solely on the connection identifier field in the header. Second, after reducing the header there are fewer bits that are required to be sent from the source to the destination. This results in a reduction in the required bandwidth which, in a satellite communication system, is a valuable resource.

It can thus be appreciated that this aspect of these teachings increases the overall capacity of the MSTS 1, as some percentage of each data packet, when transmitted with the minimized or reduced header information, is not required to be sent over the air interface.

While these teachings have been particularly shown and described with respect to preferred embodiments thereof, it will be understood by those skilled in the art that changes in form and details may be made therein without departing from the scope and spirit of these teachings.

What is claimed is:

1. A mobile satellite telecommunications system, comprising:
at least one user terminal;
at least one satellite in earth orbit; and
at least one gateway bidirectionally coupled to a data communications network;
said user terminal comprising a controller responsive to applications for selecting individual ones of a plurality of Quality of Service (QoS) modes for servicing different application requirements.

2. A system as in claim 1, wherein said user terminal operates to communicate a request for a selected one of said QoS modes at least to said gateway, and in response the system allocates resources to accommodate the requested QoS mode.

3. A system as in claim 1, wherein a user is billed a greater amount for use of a QoS of higher quality.

4. A system as in claim 1, wherein said QoS modes comprise a Highest Quality of Service mode, a Medium Quality of Service mode, a Best Available Quality of Service mode, and a Guaranteed Data Rate Packet Data Service mode.

5. A system as in claim 1, wherein said controller selects one of a circuit switched or a packet switched mode of operation.

6. A mobile satellite telecommunications system, comprising:
at least one user terminal;
a constellation of satellites in earth orbit;
at least one gateway bidirectionally coupled to a data communications network; and
a processor responsive at least to stored satellite ephemeris information for selecting a path through said satellite constellation to a destination gateway for routing a communication to or from said data communication network and said user terminal, and for causing a description of said selected path to be transmitted from said user terminal to at least one of said constellation of satellites.

7. A system as in claim 6, wherein said processor is further responsive to stored gateway location information for selecting said path through said satellite constellation to said destination gateway.

8. A mobile satellite telecommunications system, comprising:
at least one user terminal;
a constellation of satellites in earth orbit; and
at least one gateway bidirectionally coupled to a data communications network;
said user terminal comprising a controller operable for reducing an amount of information contained within a packet header after transmitting a first packet to at least one satellite of said constellation of satellites.

9. A system as in claim 8, wherein the packet header of said first packet contains information that is descriptive of at least an identification of a source address and a destination address of the packet, and a connection identifier identifying a communication connection to which the packet belongs, and wherein headers of subsequent packets of the communication connection contain only the connection identifier.

10. A system as in claim 9, wherein said satellites comprise a processor and a memory for extracting and storing the information from the header of the first packet, and for routing subsequent packets based on the stored information and on the connection identifier.

11. A system as in claim 10, wherein the subsequently transmitted packet headers are expanded to contain the stored information prior to being transmitted to the data communication network.

12. A system as in claim 9, wherein said satellites and said destination gateway comprise a processor and a memory for extracting and storing the information from the header of the first packet, and for routing subsequent packets based on the stored information and on the connection identifier.

13. A system as in claim 12, wherein the subsequently transmitted packet headers are expanded by said destination gateway to contain the stored information prior to being transmitted to the data communication network.

14. A method for operating a mobile satellite telecommunications system, comprising:
providing at least one user terminal, at least one satellite in earth orbit and at least one gateway bidirectionally coupled to a data communications network; and
responsive to applications, selecting with said user terminal individual ones of a plurality of Quality of Service (QoS) modes for servicing different application requirements.

15. A method as in claim 14, and further comprising communicating a request for a selected one of said QoS modes at least to said gateway, and in response allocating resources to accommodate the requested QoS mode.

16. A method as in claim 14, wherein a user is billed a greater amount for use of a QoS of higher quality.

17. A method as in claim 14, wherein said QoS modes comprise a Highest Quality of Service mode, a Medium Quality of Service mode, a Best Available Quality of Service mode, and a Guaranteed Data Rate Packet Data Service mode.

18. A method as in claim 14, and further comprising selecting one of a circuit switched or a packet switched mode of operation with said user terminal.

19. A method for operating a mobile satellite telecommunications system, comprising:
providing at least one user terminal, a constellation of satellites in earth orbit and at least one gateway bidirectionally coupled to a data communications network; and
responsive at least to stored satellite ephemeris information, selecting a path through said satellite constellation to a destination gateway for routing a communication to or from said data communication network and said user terminal, and transmitting a description of said selected path from said user terminal to at least one of said constellation of satellites.

20. A method as in claim 19, wherein the step of selecting a path is further responsive to stored gateway location information for selecting said path through said satellite constellation to said destination gateway.

21. A method for operating a mobile satellite telecommunications system, comprising:
providing at least one user terminal, a constellation of satellites in earth orbit and at least one gateway bidirectionally coupled to a data communications network; and
reducing an amount of information contained within a packet header after transmitting a first packet to at least one satellite of said constellation of satellites.

22. A method as in claim 21, wherein the packet header of said first packet contains information that is descriptive of at least an identification of a source address and a destination address of the packet, and a connection identifier identifying a communication connection to which the packet belongs, and wherein headers of subsequent packets of the communication connection contain only the connection identifier.

23. A method as in claim 22, further comprising extracting and storing the information from the header of the first packet in said satellites, and routing subsequent packets based on the stored information and on the connection identifier.

24. A method as in claim 23, and further comprising expanding the subsequently transmitted packet headers to contain the stored information prior to being transmitted to the data communication network.
